(19) United States
(12) Patent Application Publication
(10) Pub. No.: US 2004/0249488 A1
(43) Pub. Date: Dec. 9, 2004

(54) Method for determining a probability distribution present in predefined data

(76) Inventors: Michael Haft, Zomeding (DE); Reimar Hofmann, Munchen (DE)

Correspondence Address: STAAS & HALSEY LLP, SUITE 700, 1201 NEW YORK AVENUE, N.W., WASHINGTON, DC, 20005, US

(21) Appl. No.: 10/489,366

(22) PCT Filed: Jul. 23, 2003
(86) PCT No.: PCT/DE03/02484

(30) Foreign Application Priority Data
Jul. 24, 2002 (DE) 102-33-609.1

(51) Int. Cl. G06F 155/00

(52) U.S. Cl. 700/93

(57) ABSTRACT

For inference in a statistical model, or in a clustering model the formation of the result bitches formed from the terms of the association function or a conditional probability tables, of using the normal procedures, but as soon as the first zero occurs in the associated factors or a weight of zero has been determined for a cluster in the first steps, enabling the further calculation of the a posteriori weight to be aborted. In the case in which in an iterative learning process (e.g. an EM learning process) a cluster for a specific data point is assigned a weight of zero, this cluster will also be given the weight of zero for this data point for all further learning steps and therefore must also no longer be taken into consideration in all further learning steps. Useful data structures for buffering clusters or states of a variable which are still allowed from one learning step to the next are specified. This guarantees a meaningful removal of processing of irrelevant parameters and data. it produces the advantage that, because only the relevant data is taken into account, a faster sequence of the learning process is guaranteed.

### CROSS REFERENCE TO RELATED APPLICATIONS

This application is based on and hereby claims priority to PCT Application No. PCT/DE03/02484 filed on Jul. 23, 2003 and German Application No. 10233609.1 filed on Jul. 24, 2002, the contents of which are hereby incorporated by reference.

### BACKGROUND OF THE INVENTION

The invention relates to a method for creating a statistical model using a learning process.

The increasing traffic in the Internet allows the companies who are represented or offer services on the Internet to both exploit an increased customer base as well as collect customer-specific information. In such cases many of the electronic processes running are logged and user data is stored. Thus many companies now operate a CRM system, in which they systematically include information about all customer contacts. Traffic on Web sites or access to the sites is logged and the transactions are recorded in a call center. This often produces very large volumes of data containing the most diverse customer-specific information.

The resulting disadvantage of such a process is that although valuable information about customers is produced, the often overwhelming volume of such information means that it can only be processed with considerable effort.

To resolve this problem statistical methods are basically applied, especially statistical learning processes, which after a training phase for example possess the capability of subdividing entered variables into classes. The new field of data mining or machine learning has made it its particular aim to further develop such learning methods (such as for example the clustering method) and apply them to problems with practical relevance.

In this case many data mining methods can be directed explicitly to handling information from the Internet. With these methods large volumes of data are converted into valuable information which in general significantly reduces the data volume. Such a method also employs many statistical learning processes, in order to be able to read out statistical dependency structures or recurring patterns from the data for example.

However the disadvantage of these methods is that they are numerically a great deal of effort although they deliver valuable results. The disadvantages are further magnified by the fact that missing information such as for example the age of a customer or their income makes it more complicated to process the data or to some extent even makes the information supplied worthless. The best way of dealing statistically with such missing information has previously required a great deal of effort.

A further method of usefully dividing up information is to create a cluster model, e.g. with a naive Bayesian Network. Bayesian Networks are parameterized by probability tables. When these tables are optimized the weakness arises even after a few learning steps as a rule that many zero entries are included in the tables. This then produces sparse tables. The fact that the tables are constantly changing during the learning process, such as for example in the learning process for statistical cluster models, means that sparse coding of tables can only be utilized with difficulty. In this case the repeated occurrence of zero entries in the probability tables leads to an increased and unnecessary expenditure of calculations and memory.

For these reasons it is necessary to design the given statistical learning process so that it is faster and more powerful. In such cases what are known as EM (Expectation Maximization) learning processes are increasingly important.

To provide a concrete example of an EM learning process in the case of a Naive Bayesian cluster model the learning steps are generally executed as follows:

Here X={Xₖ, k=1, . . . , K} designates a set of K statistical variables (which can for example correspond to the fields in a database). The states of the variables are identified by lowercase letters. The variable X₁ can assume the states x_{1,1}, x_{1,2}, . . . , i.e. X₁ ε {x_{1,i}, i=1, . . . , L₁}. L₁ is the number of states of the variable X₁. An entry in a data set (a database) now includes values for all variables, with X^{π}≡x₁^{π}, x₂^{π}, x₃^{π}, . . . ) designating the πth data set. In the πth data set the variable X₁ in state x₁^{π}, the variable X₂ in state x₂^{π}, etc. The table has M entries, i.e., {X^{π}, π=1, . . . , M}. In addition there is a hidden variable or a cluster variable, designated Ω here; for which the states are {ωᵢ, i=1, . . . , N}. There are thus N clusters.

In a statistical clustering model P(Ω) now describes an a priori distribution; P(ωᵢ) is the a priori weight of the ith cluster and P(X|ωᵢ) describes the structure of the ith cluster or the conditional distribution of the observable variables (contained in the database) X={Xₖ, k=1, . . . , K} in the ith cluster. The a priori distribution and the conditional distributions for each cluster together parameterize a common probability model on X∪Ω or on X.

In a Naive Bayesian Network the requirement is that p(\vec{X}|ωᵢ) can be factorized with

$${\prod }_{k = 1}^{K} p ( {X}_{k} \vert {ω}_{i} ) .$$

In general the aim is to determine the parameters of the model, that is the a priori distribution p(Ω) and the conditional probability tables p(\vec{X}|ω) of the common model, in such a way that the data entered is reflected as well as possible. A corresponding EM learning process includes a series of iteration steps, in which case in each iteration step an improvement of the model (in the sense of a likelihood) is achieved. In each iteration step new parameters p^{neu}( . . . ) based on the current or “old” parameters p^{alt} ( . . . ) are estimated.

Each EM step initially begins with the E step, in which “Sufficient Statistics” are determined in the tables provided. The process starts with probability tables for which the entries are initialized with zero values. The fields of the tables are filled in the course of the E step with the sufficient statistics S(Ω) and S(\vec{X},Ω) by supplementing for each data point the missing information (the assignment of each data point to the clusters) by expected values. The procedure for dealing with the formation of sufficient statistics is known from Sufficient, Complete, Ancillary Statistics, available on 28 Aug. 2001 at the following Internet address http://www.math.uah.edu/stat/point/point6.html.

To calculate expected values for the cluster variable Ω the a posteriori distribution p^{alt}(wᵢ|\vec{x}^{π}) is to be determined. This step is also referred to as the inference step. In the case of a Naive Bayesian Network the a posteriori distribution for Ω is to be calculated in accordance with the rule

$${p}^{alt} ( {w}_{i} \vert {\vec{x}}^{π} ) = \frac{1}{{Z}^{π}} {p}^{alt} ( {w}_{i} ) {\prod }_{k = 1}^{K} {p}^{alt} ( {x}_{k}^{π} \vert {ω}_{i} )$$

for each data point \vec{x}^{π}from the information entered, in which case 1/Z^{π} is a normalizing constant. The essential aspect of this calculation relates to forming the product p^{alt}(\vec{x}ₖ^{π}|ωᵢ) of all k=1, . . . , K. This product must be formed in each E step for all clusters i=1, . . . , N and for all data points x^{π}, π=1, . . . , M. As much effort, often even greater effort, is the inference step for the assumption of other dependency structures than a Naive Bayesian Network, and thus includes the major numerical efforts of EM learning.

The entries in the tables S(Ω) and S(\vec{X}, Ω) change after the formation of the above product for each data point x^{π}, π=1, . . . , M, since S(ωᵢ) by p^{alt}(ωᵢ|\vec{x}^{π}) is added for all i, or forms a sum of all p^{alt}(ωᵢ|\vec{x}^{π}). Similarly S(\vec{x}, ωᵢ) or S(xₖ, ωᵢ) for all variables k in the case of naive Bayesian Network, added by p^{alt}(ωᵢ|\vec{x}^{π}) for all clusters i in each case. This initially excludes the E (Expectation) step. On the basis of this step new parameters p^{neu}(Ω) and p^{neu}(\vec{x}|Ω) are calculated for the statistical model, with p(\vec{x}|ωᵢ) representing the structure of the ith cluster or the conditional distribution of the variables \vec{X} contained in the database in this ith cluster.

In the M (maximization) step, on the basis of a general log Likelihood

$$L = {\sum }_{π = 1}^{M} log {\sum }_{i = 1}^{N} p ( {\vec{x}}^{π} \vert {ω}_{i} ) p ( {ω}_{i} )$$

new parameters p^{neu}(Ω) and p^{neu}(\vec{X}|Ω) which are based on the sufficient statistics already calculated are formed. The M step does not entail any addition numerical effort. For the general theory of EM learning see also M. A. Tanner, Tools for Statistical Inference, Springer, N.Y., 1996.

It is thus clear that the significant effort of the algorithm lies in the inference step or on the formation of the product

$${\prod }_{k = 1}^{K} {p}^{alt} ( {x}_{k}^{π} \vert {ω}_{i} )$$

and on the accumulation of sufficient statistics.

The formation of numerous zero elements in the probability tables p^{alt}(\vec{X}|ωᵢ) or p^{alt}(Xₖ|ωᵢ) can however be utilized by clever data structures and storage of intermediate results from one EM step for use in the next to efficiently calculate the products.

A general and comprehensive description of handling of learning methods using Bayesian Networks can be found in B. Thiesson, C. Meek, and D. Heckerman. Accelerating EM for Large Databases. Technical Report MSR-TR-99-31, Microsoft Research, May, 1999 (Revised February, 2001), available on 14 Nov. 2001 at the following Internet address:

http://www.research.microsoft.com/˜heckerman/, in particular the problem of partly missing data is addressed in David Maxwell Chickering und David Heckerman, available on 18 Mar. 2002 at the following Internet address:

http://www.research.microsoft.com/scripts/pubs/view.asp?TR_ID=MSR-TR-2000-15. The disadvantage of this learning process and is that sparsely-populated tables (tables with many zero entries) are processed and this causes a great deal of calculation effort and but provides no additional information about the data model to be evaluated.

### SUMMARY OF THE INVENTION

One possible object of the invention is thus to specify a method in which zero entries in probability tables can be used in such a way that no further unnecessary numerical or calculation effort is generated as a by-product.

The inventors propose that for inference in a statistical model or in a clustering model, the formation of the result, which is formed from the terms of association function or conditional probability tables, the normal procedure is followed, but as soon as the first zero occurs in the associated factors or for a cluster a weight of zero is already determined after the first steps, the further calculation of the a posteriori weight can be aborted. In the case that in an iterative learning process (e.g. an EM learning process) a

cluster is assigned the weight zero for a specific data point, this cluster will also be given the value zero in all further steps for this data point, and does not have to be taken into account any more in all further learning steps.

This guarantees a sensible removal of the processing of irrelevant parameters and data. It produces the advantage that because only the relevant data is taken into account, a faster sequence of the learning process is guaranteed.

In more precise terms, the method executes as follows: The formation of an overall product in the above inference step, which relates to factors of a posteriori distributions of association probabilities for all data points entered, is executed as normal, but as soon as a first specifiable value, preferably zero or a value approaching zero, occurs in the associated factors, the formation of the overall product is aborted. It can further be shown that if in an EM learning process a cluster for a specific data point is assigned the weight in accordance with a number of the selection described above, preferably zero, this cluster will also be assigned the weight zero in all further EM steps for this data point. This guarantees a sensible removal of superfluous numerical effort by for example buffering the corresponding results from one EM step to the next and only processing them for the clusters which do not have the weight of zero.

This produces the advantage that, because processing is aborted for clusters with zero weights not only within the EM step but also for all further steps, in particular for formation of the product in the inference step, the learning process as a whole is significantly speeded up.

In methods for determining a probability distribution present in prespecified data probabilities of association to specific classes are calculated in an iterative procedure only up to a specified value or a value of zero or practically zero and the classes with an association probability below a selected value are not used any more in the iterative procedure.

It is preferred that the specified data forms clusters.

A suitable iterative procedure would be the Expectation Maximization procedure in which a product of association factors is also calculated.

In a further development of the method a series of the factors to be calculated will be selected in such a way that the factor which belongs to a state of a variable that seldom occurs is the first be processed. This means that the values that seldom occur are stored before the start of forming the product in such a way that the variables are ordered in the list depending on the frequency of the occurrence of a zero.

It is furthermore advantageous to use a logarithmic representation of probability stages.

It is furthermore advantageous to use a sparse representation of the probability stages, e.g. in the form of a list which only contains the elements which differ from zero.

Furthermore in the calculation of sufficient statistics only those clusters which have a weight other than zero are taken into account.

The clusters which have a weight other than zero can be stored in a list, in which case the data stored in the list can be pointers to the corresponding cluster.

The method can furthermore be an Expectation Maximization learning process, in which, in the case where for a data point a cluster is given an a posteriori weight of zero, this cluster is given a weight of zero in all further steps of this EM procedure in such a way that this cluster no longer has to be taken into account in all further steps.

The procedure in this case can then only run over clusters which have a weight other than zero.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a scheme for executing one aspect of the invention;

FIG. 2 is a scheme for buffering variables depending on the frequency of their appearance; and

FIG. 3 is the exclusive consideration of clusters which have been given a weight other than ZERO.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

### I. First Exemplary Embodiment in an Inference Step

a). Formation of an Overall Product with Abort on Zero Value

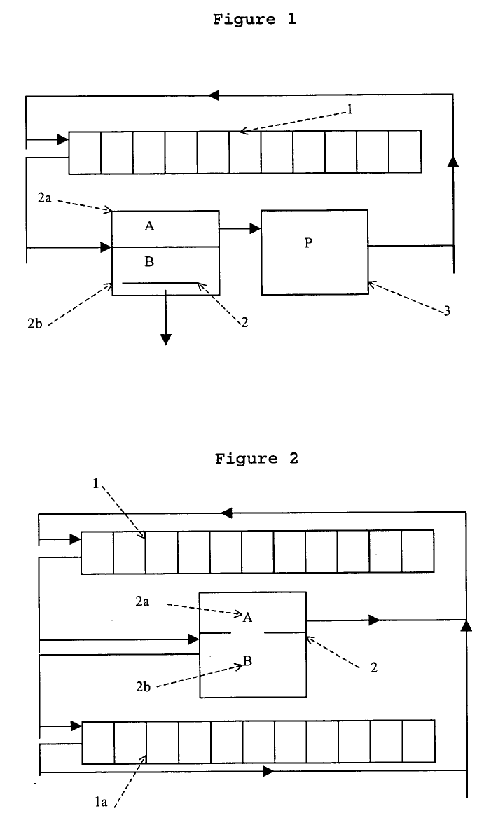

FIG. 1 shows a scheme in which, for each cluster ωᵢ in an inference step, the formation of the overall product 3 is executed. As soon as the first zero 2b occurs in the associated factors 1, which can be typically read out from a memory, array or pointer list, the formation of the overall product 3 is aborted (output). In the case of a zero value the a posteriori weight belonging to the cluster is then set to zero. Alternatively a check can also first be made as to whether at least one of the factors in the product is zero. In this case all multiplications for forming the overall product are only executed if all factors are other than zero.

If on the other hand no zero value occurs for a factor belonging to the overall product, represented by 2a, the formation of the product 3 will be continued as normal and the next factor 1 read out from the memory, array or pointer list and used for further formation of product 3 with the condition 2.

b). Advantages of Aborting the Formation of the Overall Product if Zero Values Occur

Since the inference step does not unconditionally have to be a part of an EM learning process, this optimization is also of particularly great significance in other detection and forecasting procedures in which an inference step is needed, e.g. for the detection of an optimum offering in the Internet for a customer for whom information is available. On this basis targeted marketing strategies can be created, in which the detection or classification capabilities lead to automated reactions, which send information to a customer for example.

c). Selection of a Suitable Order for Speeding Up Data Processing

FIG. 2 shows a preferred development of the method in which a smart order is selected such that, if a factor in the product is zero, represented by 2a, there is a high probability of this factor occurring very soon as one of the first factors in the product. This means that the creation of the overall product 3 can be aborted very soon. The definition of the new order 1a can be undertaken in this case in accordance with the frequency with which the states of the variables occur in the data. Here for example a factor which belongs to a state of the variable which occurs very infrequently can be processed first. The order in which the factors are processed can thus be determined once before the start of the learning procedure by storing the values of the variables in a correspondingly arranged list 1a.

d). Logarithmic Representation of the Tables

To restrict the computing effort of the procedure described above as much as possible, a logarithmic representation of the tables is preferably used, in order to avoid underflow problems for example. With this function original zero elements can for example be replaced by a positive value. This means that the effort of processing or separating the values the which are almost zero and differ from each other by a very small amount is no longer necessary.

e). Bypassing Increased Summation in Calculating Sufficient Statistics

In the case in which the stochastic variables given to the learning procedure only have a low probability of belonging to a specific cluster, many clusters will have the a posteriori weight of zero in the course of the learning procedure. In order to speed up the accumulation of the sufficient statistics in the following step only those clusters are taken into account in this step which have a weight other than zero. in this case it is advantageous to increase the performance of the learning process in such a way that the clusters which are different from zero are assigned and stored in a list, an array or a similar data structure, which allows only the elements that differ from zero to be stored.

### II. Second Exemplary Embodiment in an EM Learning Procedure

a). Not Taking into Account Clusters with Zero Assignments for a Data Point.

In particular here in an EM learning procedure information is stored from one step of the learning procedure to the next step as to which clusters as a result of the occurrence of zeros are still allowed in the tables and which are no longer allowed. Where, in the first exemplary embodiment, clusters which were given an a posteriori weight of zero by being multiplied by zero are excluded from all further calculations in order to save on a numerical effort, in this embodiment, intermediate results regarding a cluster association to individual data points (which clusters are already excluded or still allowed) are also stored from one EM step to the next in data structures which are additionally necessary. This makes sense since it enables you to see that a cluster which has been given the weight of zero for a data point in an EM step will also be given the weight zero in all further steps.

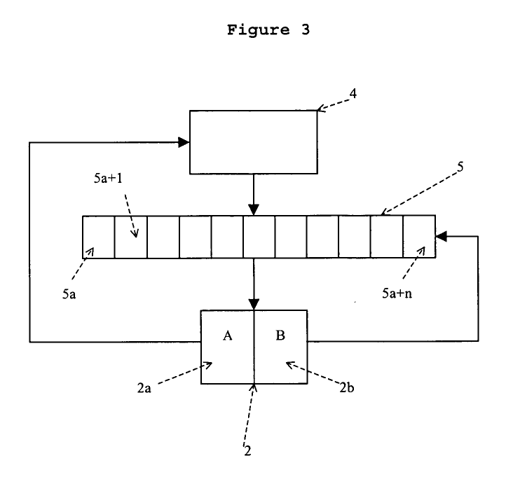

FIG. 3 gives a concrete example of the case in which, where a data point 4 is assigned to a cluster with a practically zero probability 2a, the cluster can again immediately be set to zero in the next step of the learning procedure 5a+1, where the probability of this assignment of the data point is calculated again. This means that a cluster, which in an EM step 5a for a data point 4 has been given a value of zero via 2a, is not only not considered any further within the current EM step, 5a, but will not be considered in any further EM steps 5a+n, where n represents the number of EM steps used (not shown), of this cluster via 2a. An association of a data point to a new cluster can then continue to be calculated via 4. An almost non-zero association of a data point 4 to a cluster leads to a continued calculation via 2b to the next EM step 5a+1.

b). Storing a List with References to Relevant Clusters

For each data point a list or a similar data structure can first be stored which contains references to the relevant clusters which have been given a weight for this data point that is other than zero. This guarantees that in all operations or procedural steps, for forming the overall product and accumulating the sufficient statistics, the loops only run over the clusters which are still relevant or still allowed.

Overall only the allowed clusters are stored in this exemplary embodiment, but in a data record for each data point.

### III. Further Exemplary Embodiment

A combination of the exemplary embodiments already mentioned is included here. A combination of the two exemplary embodiments enables the procedure to be aborted on a zero weight in the inference step, in which case in further EM steps only the allowed clusters are taken into consideration, as in the second exemplary embodiment.

This creates an EM learning process which is optimized overall. Since the use of cluster models for detection and forecasting procedures is generally employed, an optimization in accordance with the method is of particular advantage and value.

### IV. Arrangement for Executing the Method

The method according to one or all exemplary embodiments can basically be implemented with a suitable computer and memory arrangement. The computer-memory arrangement in this case should be equipped with a computer program which executes the steps in the procedures. The computer program can also be stored on a data medium such as a CD-ROM and thereby be transferred to other computer systems and executed on them.

A further development of the the computer and memory arrangement relates to the additional arrangement of an input and output unit. In this case the input units can transmit information of a state of an observed system such as for example the number of accesses to the Internet page via sensors, detectors, keyboards or servers, into the computer arrangement or to the memory. The output unit in this case would include hardware which stores or displays on a screen the signals of the results of the processing in accordance with the method. An automatic, electronic reaction, for example the sending of a specific e-mail in accordance with the evaluation according to the method is also conceivable.

### V. Application Example

The recording of statistics on the use the Web site or the analysis of Web traffic is also known today and referred to as Web mining. A cluster found by the learning procedure can for example reflect a typical behavior of many internet users. The learning procedure typically allows the detection of the fact that all the visitors from a class or to whom the cluster found by the learning procedure was assigned for example do not remain in a session for more than one minute and mostly only call up one page.

Statistical information about the users of a Web site who come to the analyzed Web page via a freetext search machine, can also be determined. Many of these users for example only request one document. They could for example mostly request documents from the freeware and hardware area. The learning procedure can determine the assignment of the users who come from a search machine to different clusters. In this case a plurality of clusters are already almost excluded, in which case another cluster can be given a relatively high weight.

The invention has been described in detail with particular reference to preferred embodiments thereof and examples, but it will be understood that variations and modifications can be effected within the spirit and scope of the invention.

1-16. (cancelled).

17. A method of determining a probability distribution present in prespecified data, comprising:
initially calculating association probabilities for all classes that have an association probability less than or equal to a specifiable value, the initial calculation of association probabilities being performed using an iterative procedure; and
subsequently using the iterative procedure to calculate association probabilities for classes only if the resulting association probabilities are below a selectable value.

18. The method in accordance with claim 17, wherein the specifiable value is zero.

19. The method in accordance with claim 17, wherein the prespecified data forms clusters.

20. The method in accordance with claim 17, wherein the iterative procedure includes an expectation maximization algorithm.

21. The method in accordance with claim 20, wherein association probabilities are calculated by calculating a product of probability factors.

22. The method in accordance with claim 21, further comprising ceasing calculation of the product of probability factors when one of the probability factors shows a valve approaching zero.

23. The method in accordance with 20, wherein the calculation of the product of probability factors is performed so that a probability factor associated with a variable which seldom occurs is processed before a probability factor associated with a variable which often occurs.

24. The method in accordance with claim 23, wherein
an ordered list is used in the calculation of the product of probability factors,
the ordered list contains probability factors and products,
probability factors associated with a variable which seldom occurs are stored before the beginning of the products in the ordered list, the probability factors being arranged in the ordered list in accordance with the frequency of their occurrence.

25. The method in accordance with claim 17, wherein a logarithmic representation of probability tables is used in calculating association probabilities.

26. The method in accordance with claim 17, wherein the representation of the probability tables only employs a list only containing elements that differ from zero.

27. The method in accordance with claim 17, wherein sufficient statistics are calculated.

28. The method in accordance with claim 27, wherein
the prespecified data forms clusters, and
for the calculation of sufficient statistics, only those clusters are taken into account which have a weight other than zero.

29. The method in accordance with claim 17, wherein
the prespecified data forms clusters, and
the clusters which have a weight other than zero are stored in a list.

30. The method in accordance with claim 17, wherein
the association probabilities are calculated in an expectation maximization learning process,
the prespecified data has data points that form clusters,
when a cluster is given an a posteriori weight of zero for a data point, the cluster is given a weight of zero in all further steps for the data point,
when a cluster is given an a posteriori weight of zero, the cluster is not considered in subsequent expectation maximization process steps.

31. The method in accordance with claim 29, wherein,
wherein the prespecified data has data points that form clusters, and
for each data point, a list of all references to clusters which have a weight other than zero is stored.

32. The method in accordance with claim 26, wherein the iterative process is performed only for clusters which have a weight other than zero.

33. The method in accordance with claim 18, wherein the prespecified data forms clusters.

34. The method in accordance with claim 33, wherein the iterative procedure includes an expectation maximization algorithm.

35. The method in accordance with claim 34, wherein association probabilities are calculated by calculating a product of probability factors.

36. The method in accordance with claim 35, further comprising ceasing calculation of the product of probability factors when one of the probability factors shows a valve approaching zero.

37. The method in accordance with 35, wherein the calculation of the product of probability factors is performed so that a probability factor associated with a variable which seldom occurs is processed before a probability factor associated with a variable which often occurs.

38. The method in accordance with claim 37, wherein
an ordered list is used in the calculation of the product of probability factors,
the ordered list contains probability factors and products,
probability factors associated with a variable which seldom occurs are stored before the beginning of the products in the ordered list, the probability factors being arranged in the ordered list in accordance with the frequency of their occurrence.

39. The method in accordance with claim 38, wherein a logarithmic representation of probability tables is used in calculating association probabilities.

40. The method in accordance with claim 39, wherein the representation of the probability tables only employs a list only containing elements that differ from zero.

41. The method in accordance with claim 40, wherein sufficient statistics are calculated.

42. The method in accordance with claim 41, wherein
the prespecified data forms clusters, and
for the calculation of sufficient statistics, only those clusters are taken into account which have a weight other than zero.

43. The method in accordance with claim 38, wherein
the prespecified data forms clusters, and
the clusters which have a weight other than zero are stored in a list.

44. The method in accordance with claim 39, wherein
the association probabilities are calculated in an expectation maximization learning process,
the prespecified data has data points that form clusters,
when a cluster is given an a posteriori weight of zero for a data point, the cluster is given a weight of zero in all further steps for the data point,
when a cluster is given an a posteriori weight of zero, the cluster is not considered in subsequent expectation maximization process steps.

45. The method in accordance with claim 43, wherein,
wherein the prespecified data has data points that form clusters, and
for each data point, a list of all references to clusters which have a weight other than zero is stored.

46. The method in accordance with claim 41, wherein the iterative process is performed only for clusters which have a weight other than zero.

47. A system to determine a probability distribution present in prespecified data, comprising:
a first calculation unit to calculate association probabilities for all classes that have an association probability less than or equal to a specifiable value, the initial calculation of association probabilities being performed using an iterative procedure; and
a second calculation unit to subsequently use the iterative procedure to calculate association probabilities for classes only if the resulting association probabilities are below a selectable value.

48. The system in accordance with claim 47, wherein the specifiable value is zero.

49. The system in accordance with claim 47, wherein the prespecified data forms clusters.

50. The system in accordance with claim 47, wherein the iterative procedure includes an expectation maximization algorithm.

51. The system in accordance with claim 50, wherein association probabilities are calculated by calculating a product of probability factors.

52. The system in accordance with claim 51, further comprising ceasing calculation of the product of probability factors when one of the probability factors shows a valve approaching zero.

53. The system in accordance with 50, wherein the calculation of the product of probability factors is performed so that a probability factor associated with a variable which seldom occurs is processed before a probability factor associated with a variable which often occurs.

54. The system in accordance with claim 53, wherein
an ordered list is used in the calculation of the product of probability factors,
the ordered list contains probability factors and products,
probability factors associated with a variable which seldom occurs are stored before the beginning of the products in the ordered list, the probability factors being arranged in the ordered list in accordance with the frequency of their occurrence.
